(19) United States
(12) Patent Application Publication
(10) Pub. No.: US 2003/0074449 A1
(43) Pub. Date: Apr. 17, 2003

(54) Bandwidth allocation in a synchronous transmission network for packet oriented signals

(76) Inventors: Rory Smith, Belfast (GB); Jaqueline Hendron, Templepatrick (GB); Ivor Rea, Belfast (GB)

Correspondence Address: William M. Lee, Jr., Lee, Mann, Smith, McWilliams, Sweeney & Olhlson, Suite 410, 209 South LaSalle Street, Chicago, IL, 60604-1202, US

(21) Appl. No.: 09/975,841

(22) Filed: Oct. 12, 2001

(51) Int. Cl. G06F 15/173

(52) U.S. Cl. 709/226

(57) ABSTRACT

A method of transporting a packet oriented client signal which uses a buffer-to-buffer flow control mechanism over a synchronous transmission network by assigning an arbitrary synchronous payload, where the synchronous payload bandwidth may be significantly smaller than the full bandwidth of the client signal. Flow control over the synchronous network is provided by the buffer-to-buffer flow control mechanism of the client signal to automatically regulate the data throughput to ensure no data can be lost. The method is independent of the Client Signal Data Rate and the provisioned SDH/SONET bandwidth, and SDH/SONET payload which may be non-concatenated, contiguously concatenated, or virtually concatenated. In particular, the method may be used to support the transport of Fibre Channel (1G, 2G and 4G), and ESCON (200M) in a synchronous payload.

### FIELD OF THE INVENTION

The present invention relates to a method of mapping a packet orientated client signal to a synchronous network payload. In particular, but not exclusively to a method of allocating bandwidth in a synchronous digital network for a packet oriented signal having buffer-to-buffer flow control, and to related aspects thereof.

In this document, the use of the term a synchronous network infers a reference to a SONET (Synchronous Optical NETwork) and/or a SDH (Synchronous Digital Hierarchy) network. The use of either the term SDH or SONET does not exclude a reference to the other such as a person skilled in the art would appreciate.

Such synchronous networks support a hierarchical multiplexing structure of synchronous network signals. Thus the payloads of synchronous network signal frames are able to transport lower-speed signals within containers, and smaller containers can be encapsulated within larger containers.

Two types of client signal are normally carried within such synchronous network payloads. The first type of client signal is a constant bit rate signal such as a PDH (Pleisosynchronous Digital Hierarchy) signal. The second type is a packet oriented client signal, comprising data packets interspersed with inter packet gaps such as, for example, a Fibre Channel or Ethernet signal. The use of the terms “frame” and “packet” are used here in an equivalent sense when referring to packet oriented signals, and use of either word should not exclude a reference to the other such as a person skilled in the art would appreciate.

Several different types of protocol exist for packet oriented client signals. These protocols come in a variety of bandwidths (e.g. Fibre Channel supports 500 Mbits/s, 1 Gbits/s, 2 Gbits/s), many of which do not fit neatly into any synchronous network payload containers.

Fibre Channel and ESCON are two protocols which fall into a particular sub-class of packet oriented protocols which can use a buffer-to-buffer flow control mechanism. Such a flow control mechanism helps to ensure that the buffers of receiving and transmitting ports along a particular communications path do not overflow, which could cause data to be lost and/or retransmitted.

Geographically dispersed Fibre Channel/ESCON sits can interconnect using other transport mechanisms such as synchronous networks, however several problems are known in the art to be associated with conventional techniques.

Firstly, over long distances, the length of time taken by a receiver ready signal (or any other signal used to implement buffer-to-buffer flow control) to be communicated between connected nodes can be substantial. As a result, long pauses are generated whilst waiting for signals to proceed with transmission. This results in an inefficient use of the synchronous network bandwidth which has been allocated for the transmission.

It is known that a simple way to transport a packet oriented client signal is to transport the complete signal as received at the physical layer. This involves choosing a suitable synchronous payload size that is larger than the physical signal, then mapping the entire client signal (each bit) into the designated payload for transport, This is a fixed mapping technique where the payload is a pre-defined size for each type of physical signal. However, the technique has several disadvantages. Firstly the signal must be mapped to the next available payload size. Secondly it is unlikely the client signal will operate continuously at its full bandwidth rate.

A more complex conventional way to transport a Packet Oriented Client Signal is to do some manipulation of the Protocol in order to fit it into a synchronous network payload which is smaller than the full bandwidth of the Client Signal. Such conventional techniques are complex, as protocol dependent functions to manage flow control must be provided in order to prevent loss of data.

Allocating bandwidth for packet oriented client signals in a synchronous network is not nearly as straight forward as for PDH signals. There is a strong demand from telecommunications and data communications bandwidth providers to be able to satisfy specific cost and bandwidth demands by consumers upon request. To help meet this requirement for different data protocols and customer bandwidth demands, contiguous and virtual concatenation techniques are often employed.

Virtual containers may provide bandwidth subdivisions which are able to float between the payload areas of adjacent frames, with each subdivision being locatable by its pointer embedded in the frame overheads. Concatenation of virtual containers may be provided in a contiguous or in a virtual form. Contiguous concatenation techniques have several disadvantages compared to virtual concatenation. In particular contiguous concatenation requires any intermediate node along a transmission path to have sufficient capability to both recognise that the containers are concatenated and to handle the bandwidth of the concatenated containers. This requires all intermediate nodes to have sufficient port capacity and connection capabilities for the largest expected size of concatenated containers. Modifying existing intermediate nodes and/or providing new intermediate network nodes to have the capacity to cope with contiguous concatenated containers is both costly and time consuming. Unlike contiguously concatenated containers, virtually concatenated containers are not sent contiguously and the concatenation is apparent only at the source and destination.

Another difference is that the bandwidths defined for contiguous concatenation do not scale well, whereas virtual concatenation rates are much more scalable. For example, contiguous concatenation standard rates include STS3c (155 Mbits), STS12c (620 Mbits), and VC4-4c (620 Mbits), whereas virtual concatenation rates include: VC3-2v (102 Mbits), VC3-4v (204 Mbits), VC4-2v (310 Mbits), VC4-3v (465 Mbits). Here the relevant (non-concatenated) rates are: VC-12 (2 Mbits), VC3 (51 Mbits), STS1 (51 Mbits), and VC4 (155 Mbits)

Although contiguous and particularly virtual concatenation provide many different payload sizes in which to transport client signals, in reality very few payload rates are supported for most protocols. In addition, the payload rates that are supported vary widely from one client signal to another client signal. There are several reasons for this including, the lack of granularity of contiguous concatenation, the relatively recent introduction of virtual concatenation, the complexity involved in implementing virtual concatenation, and the complexity of protocol specific functions required to support payloads less than the full bandwidth of the client signals.

There is no single known mapping technique for packet oriented client signals employing buffer-to-buffer flow controls which supports a range of virtually concatenated synchronous network payloads. For example, with Fibre Channel packet oriented client signals, three methods are known which can carry the signal over a synchronous network.

The first technique is for the Fibre Channel packet oriented client signal to be mapped to a SONET/SDH payload via ATM (Asynchronous Transfer Mode). This technique is limited to contiguous concatenation (STS1, STS3c, STS12c, VC4, VC4-4c), and requires many complex Fibre Channel and ATM functions.

Secondly, Fibre Channel can be mapped to a SONET/SDH payload via HDLC (High-level Data Link Control). This technique similarly is limited to contiguous concatenation and requires complex protocol functions to achieve the mapping.

Thirdly, Fibre Channel signal can be mapped to a SONET/SDH payload as defined in the T1X1 ITU standard, which can be accessed via the standards section of the ITU website found at www.itu.org. This technique uses virtually concatenated payloads to carry a full bandwidth 1 Gbits/s Fibre channel client. No complex protocol specific processing is required as implementation is limited to a single synchronous payload (VC4-6v for SDH, STS3c-6v for SONET) The technique cannot therefore be scaled to meet specific customer bandwidth and cost requirements, and is accordingly inflexible.

Another disadvantage of the third method is that the buffer-to-buffer flow control mechanism escalates the problem of bandwidth wastage in that as data throughput decreases with distance, more bandwidth is wasted. For example, with 60 buffer credits allocated over 120 km Fibre Channel throughput declines to 50% by 240 km, to 25% by 500 km, etc, and the redundant portion of the payload increases accordingly.

Yet another disadvantage of the third method is that this size of bandwidth will have limited connection options in the network. For example, the 1G fibre channel signal would require an STM-16 or greater rate interface

One technique known to transport ESCON over a synchronous network is identical to that of the third method detailed above, except where the full bandwidth of the client signal is 200 Mbits/s. As for Fibre Channel, this technique uses a mapping limited to a single rate (i.e. VC3-4v for SDH, STS1-4v for SONET), and similar disadvantages apply.

### OBJECTS OF THE INVENTION

The invention seeks to mitigate and/or obviate the above mentioned problems associated With the prior art by providing a method of allocating a variable amount of bandwidth in a synchronous transmission network so that scaleable bandwidth is provided without having to perform complex protocol specific functions.

A further object of the invention seeks to provide a method of mapping a packet oriented signal having buffer-to-buffer flow control provided by a client signal network to a synchronous payload for transport to another client signal network.

A further object of the invention seeks to provide a method of load balancing synchronous traffic comprising client signals across a synchronous network.

### SUMMARY OF THE INVENTION

A first aspect of the invention seeks to provide a method of mapping a packet orientated client signal to a synchronous network payload, the method including the steps of:

receiving said client signal;

processing said client signal to a form suitable for mapping to said payload which preserves a buffer-to-buffer flow control mechanism of the client signal, wherein said step of processing reduces the bandwidth of the client signal while maintaining the integrity of a payload of the client signal;

and mapping said processed signal to said synchronous network payload.

Advantageously, the invention provides a simple solution which does not require any flow control or buffer credit management functionality, and any intermediate mapping to other OSI layer-2 protocols such as ATM

Preferably, the bandwidth is reduced by removing redundant information from said client signal.

Preferably, the bandwidth is reduced by removing idles from said client signal.

Preferably, the bandwidth is reduced by removing at least one primitive sequence which forms part of a series of repeated primitive sequences in said client signal.

Advantageously, the invention removes non-essential signals from a received data stream so that a signal with a reduced bandwidth can be transmitted over a synchronous communications network, such as a SONET/SDH network. Any client signal suitably formatted for transportation over a synchronous communications network typically includes redundant signalling code, for example, idles, which are provided between the client signal frames. It is highly advantageous if these idle signals can be removed to reduce the amount of bandwidth used. There is no need to retain signal integrity on a bit by bit basis such as a PDH (pleisiosynchronous digital hierarchy) would require. Any appropriate client signal protocols for transmission in a synchronous digital environment which incorporate some redundancy, for example, 10B encoded signals such as Fibre Channel, ESCON, or Gigabit Ethernet, may be optimised for bandwidth allocation by removal of redundant signals. Similarly, it is advantageous if the bandwidth taken up by any primitive sequences being transmitted over the network can be reduced.

Preferably, in the step of preserving the buffer-to-buffer flow control mechanism of the client signal, said buffer-to-buffer flow control mechanism is provided according to a Fibre Channel protocol class of service.

Alternatively, in the step of preserving the buffer-to-buffer flow control mechanism of the client signal, said buffer-to-buffer flow control mechanism is provided according to an ESCON protocol class of service.

Alternatively, said packet orientated client signal is provided according to a higher level protocol supported by said Fibre Channel protocol and which has a buffer-to-buffer flow control mechanism provided according to a Fibre Channel protocol class of service.

Preferably, the synchronous payload is taken from the group consisting of: one or more SONET virtual container payloads, one or more SDH virtual container payloads; two or more virtually concatenated SONET virtual container payloads; two or more virtually concatenated SDH virtual container payloads; two or more contiguously concatenated SONET virtual container payloads; two or more contiguously concatenated SDH virtual container payloads.

Advantageously, the invention permits virtual concatenation to be used to transport a client signal using a plurality of smaller bandwidth virtual containers which are then separately transported across the SDH/SONET network. The virtually concatenated containers are then recombined at the end point of the transmission.

Preferably, said step of processing the client signal further includes a step of removing line encoding.

Preferably, said first aspect further includes the step of padding said processed client signal so that said processed client signal is appropriately padded to fill a predetermined synchronous payload bandwidth.

Preferably, said the bandwidth of the synchronous payload is allocated by a network management system. Alternatively, the bandwidth of the synchronous payload is allocated by apparatus implementing the method of mapping.

Advantageously, the bandwidth allocation may be allocated automatically based on a Client signal data rate measured or derived from other embodiments of the invention. For example, bandwidth may be allocated according to feedback regarding the routing of client signals previously mapped to virtual container(s) of a certain bandwidth.

Preferably, the synchronous payload bandwidth is modified in response to customer bandwidth demands increasing/decreasing. Alternatively, the synchronous payload bandwidth is modified in response to changes in data throughput as distance between the end data packet nodes changes.

Preferably, a plurality of clients signals are multiplexed together to share said synchronous payload.

A second aspect of the invention seeks to provide a method of mapping a packet oriented client signal that uses a buffer-to-buffer flow control mechanism to a synchronous transmission network payload, the method comprising the steps of:

processing said client signal to remove at least one ordered set provided according to a protocol of said client signal to form a second signal;

storing the second signal in an ingress buffer; and

mapping the second signal to said synchronous payload,

wherein said steps of processing said client signal and mapping said second signal preserve the buffer-to-buffer flow control mechanism of the client signal and maintains the integrity of the payload of the client signal.

Preferably, said ordered set provides redundant data in said client signal.

Preferably, said ordered set provides redundant data comprising at least one client signal idle.

Alternatively, said ordered set provides redundant data comprising at least one client signal primitive sequence which is repeated in a series of client signal primitive sequences.

A third aspect of the invention seeks to provide a method of restoring a packet oriented client signal from at least one synchronous network payload, the method comprising the steps of:

receiving said synchronous payload;

de-mapping said signal from said synchronous payload;

storing said signal in an egress buffer; and

processing said signal to add at least one ordered set provided according to a protocol of said packet orientated client signal, wherein said method of restoring the client signal maintains the integrity of the payload of said packet oriented client signal and preserves a buffer-to-buffer flow control mechanism of said client signal.

Preferably, said step of de-mapping includes removing a padding character added to said signal prior to being mapped to said synchronous payload.

Preferably, said at least one ordered set is a client signal idle inserted between client signal packets in said signal according to the client signal protocol.

Preferably, said at least one ordered set is a primitive sequence inserted to form a series of primitive sequences in accordance with the client signal protocol.

A fourth aspect of the invention seeks to provide apparatus adapted to perform steps in a method of mapping a client signal comprising a packet oriented client signal that uses a buffer-to-buffer flow control mechanism to a synchronous transmission network payload, the apparatus comprising:

a processor for processing said client signal to remove at least one ordered set provided according to a protocol of said client signal to form a second signal;

a buffer for storing the processed client signal in an ingress buffer; and

a mapper for mapping the processed client signal to said synchronous payload,

wherein said apparatus preserves the buffer-to-buffer flow control mechanism of the client signal and maintains the integrity of the payload of the client signal.

For example, the apparatus may comprise part of a node and/or be a card forming part of a network element, e.g. a port card.

Preferably, the apparatus is provided in a network element supporting said client signal.

Alternatively, the apparatus is provided in a network element supporting said synchronous network payload.

For example, a network element may comprise a multiplexer, cross-connect, switch, or other active device, and may include apparatus comprising a plurality of nodes, for example, line cards etc, such as are known to those skilled in the art.

A fifth aspect of the invention seeks to provide a network element comprising apparatus according to the fourth aspect and any features thereof.

A sixth aspect of the invention seeks to provide a signal comprising a set of one or more synchronous containers, wherein the payload of said one or more synchronous containers comprises a client signal adapted to a reduced bandwidth format, wherein the integrity of the payload of said client signal is preserved in said synchronous payload, and wherein a buffer-to-buffer flow control mechanism of said client signal is preserved in said synchronous payload.

A seventh aspect of the invention seeks to provide a method of load balancing traffic comprising a packet orientated client signal across a synchronous network, wherein said traffic comprises at least one synchronous network payload comprising a packet oriented client signal which is controlled by a buffer-to-buffer flow control mechanism, the signal having been mapped to a synchronous network payload using a method including the steps of; receiving said client signal; processing said client signal to a form suitable for mapping to said payload which preserves a buffer-to-buffer flow control mechanism of the client signal, wherein said step of processing reduces the bandwidth of the client signal while maintaining the integrity of a payload of the client signal; and mapping said processed signal to said synchronous network payload, wherein said method of load balancing comprises the steps of:

pre-allocating an initial bandwidth of said synchronous network payload according to a predetermined condition, wherein said payload comprises a plurality of virtually concatenated virtual containers;

diversely routing said synchronous network payload over said synchronous network; and

in the event of a change in a condition of the network, modifiying the allocated bandwidth.

Preferably, the bandwidth is automatically modified.

Preferably, in the step of modifying the allocated bandwidth, the bandwidth is automatically modified by the apparatus performing the method of mapping.

Preferably, in the step of pre-allocating an initial bandwidth, the pre-allocated bandwidth is determined by requirements requested by a user of the network.

Alternatively, in the step of pre-allocating an initial bandwidth, the pre-allocation is automatic

Alternatively, in the step of pre-allocating an initial bandwidth, the pre-allocation is determined by the condition of the synchronous network.

A condition of the network for example, may be that a fault occurs affecting some portion of the network.

Advantageously, load balancing is facilitated by some embodiments of the invention in which client signals are mapped to virtually concatenated containers. The invention utilises the feature of virtual concatenation to diversely route data across the network and re-assemble data at the destination. If one of the paths is lost the service will continue to operate on the remaining containers at a reduced bandwidth. This obviates any need to permanently reserve protection bandwidth in the manner of a conventionally protected transport service.

An eighth aspect of the invention seeks to provide a method of allocating bandwidth in a synchronous digital network for a packet oriented signal having buffer-to-buffer flow control, the method comprising the steps of:

received said packet oriented signal;

processing said packet oriented signal to a processed signal having a form suitable for mapping to a synchronous network payload, wherein the processing preserves a buffer-to-buffer flow control mechanism of said packet oriented signal, wherein said step of processing removes redundant information from the packet oriented signal while maintaining the integrity of a payload of the packet oriented signal;

and mapping said processed signal to a said synchronous network payload having a bandwidth determined according to the bandwidth of said processed signal.

Any of the preferred features and advantages may be combined with other preferred features and advantages, and may be combined with any of the aspects of the invention as appropriate, as would be apparent to those skilled in the art.

Several advantages are provided by the invention which will now be described under three general areas.

Firstly, the invention advantageously removes the need to preserve permanently protection bandwidth over a network. Virtually concatenated containers may be routed diversely over the network. At the destination, any differential delay between containers is resolved by appropriate buffering until the containers can be reassembled. If one path is lost, service can continue to operate on the remaining containers, which offers a significant cost saving compared to a conventional protected transport service where protection bandwidth is permanently allocated.

Advantageously, by utilising virtual concatenation, no modification of intermediate equipment is required as only the source and destination nodes are required to know that the virtual containers are virtually concatenated.

Secondly, the invention advantageously exploits the inherent flow control mechanisms which are provided by certain classes of service supporting buffer-to-buffer flow control in point-to-point network topologies, for example in certain classes of service supported by client signals such as Fibre Channel and ESCON.

Buffer-to-buffer flow control regulates traffic along a link between a transmitter port and a receiver port by controlling the rate at which the transmitter can send data to the receiver. A transmitter is able to transmit a frame along a link only if the receiver has indicated it can accept the frame. It is known to those skilled in the art that in this context, a client signal frame contains the information to be transmitted (payload), the address of the source and destination ports, and/or link control information. The Generic Framing Procedure (GFP) specified in ANSI T1X1.5/2001-024R3, includes both common (protocol independent) and client-specific (protocol dependent) mapping features for GFP framed payloads into a synchronous transport signal (STS) synchronous payload envelope (SPE). However, the invention modifies the GFP according to T1X1 in an advantageous manner.

Buffering may be required for any one of a number of reasons. For example, the client signal may need to be buffered to mitigate the effects of any congestion along its route/at its destination. The buffer size needs to be sufficient for the buffer credits allocated to the link, for example, at least equal or greater than the number of allocated buffer credits. The data packet protocol rules dictate that the number of packets in transit on the link cannot exceed the buffer credits assigned to the link. This ensures that the buffer does not overflow.

Advantageously, the invention uses the buffer credit link flow control mechanism of Fibre Channel, and ESCON, to ensure that no buffer overflow occurs when handing-off between the different client signal data rates and SONET/SDH payload rates.

Thirdly, the invention advantageously provides high speed transmission over the SONET/SDH network without the unnecessary waste of bandwidth which would result if the bandwidth could not be tuned to match the customer requirements.

Advantageously, the invention therefore enables a carrier to offer scaleable bandwidth and price the service according to the capacity the customer chooses to purchase—i.e., the client signal is mapped to a payload constructed from a number of containers whose capacity is less than the client signal rate. This enables the carrier to adjust the capacity of the SDH/SONET pipe according to customer requirements.

Advantageously, the invention allows SONET/SDH bandwidth to be used more efficiently over longer distances as there is usually a loss of data throughput as the transport distance increases.

Advantageously, bandwidth can be increased/decreased to meet changes in customer bandwidth/cost requirements and by tailoring the bandwidth to match the throughput for a given distance significant cost savings can be achieved over the alternative, conventional scenario in which a full rate pipe is allocated which ends up being only partially full.

Advantageously, connectivity in the synchronous network is improved as the invention enables client signals to be mapped to a range of smaller SONET/SDH payloads. This enables for example a Fibre Channel client signal to be mapped to a payload that can be transported via an OC12/STM4 interface or even an OC3/STM1 interface, Similarly, an ESCON signal could be transported via an OC3/STM1 interface. This significantly increases the available connections in the SONET/SDH network as the availability of the lower rate interfaces such as OC3/STM1 and OC12/STM4 is much greater than that of OC48/STM16.

Advantageously, the invention thus enables a Fibre Channel signal having a bandwidth larger than an interface to be mapped to an SDH/SONET container having a bandwidth equal to or smaller than the interface. This enhances the capability of a synchronous network to add, remove and connect such signals.

Advantageously, the transport of Fibre Channel (1G, 2G and 4G), and ESCON (200M) in a synchronous payload is supported. End-to-end data integrity is maintained by using a buffer-to-buffer flow control mechanism of the data packet protocol to control buffers within the network elements at both the transmitting and receiving nodes. The use of these buffers automatically regulates the data throughput to ensure no data can be lost.

Advantageously, by providing transparency to the client signal, client signal nodes at each side of the synchronous link appear on the same client network. This simplifies management of the client network.

Advantageously, the invention enables performance monitoring of the client signal at ingress/egress to the synchronous network.

It is a particular advantage that the synchronous nodes are not able to interfere with the flow control mechanism of the client signal.

### BRIEF DESCRIPTION OF THE DRAWINGS

In order to show how the invention may be carried into effect, embodiments of the invention are now described below by way of example only and with reference to the accompanying figures in which:

FIG. 1 sketches the hierarchical layers in the Fibre Channel protocol;

FIGS. 2A and 2B illustrate the different flow control mechanisms for class 2 and class 3 Fibre Channel service;

FIG. 3A sketches a network topography in which two client signal protocol networks communicate over a synchronous network;

FIG. 3B sketches port to port connectivity of a link between node A and node Z over the network sketched in FIG. 3A in an embodiment of the invention;

FIG. 4A shows key steps in an overview of how a client signal is transported across a SONET/SDH network according to the invention;

FIG. 4B shows a preferred embodiment of the invention comprising steps in a method of mapping a packet orientated signal to a synchronous network payload, and steps in a method of restoring a packet oriented signal from a synchronous network payload

FIG. 4C shows various steps in a method of mapping a packet orientated signal to a synchronous network payload which may be implemented in various embodiments of the invention;

FIG. 4D shows various steps in a method of restoring a packet orientated signal from a synchronous network payload which may be implemented in various embodiments of the invention; and

FIG. 5 shows steps in a method of mapping a client signal data frame to a synchronous payload according to an embodiment of the invention.

### DETAILED DESCRIPTION OF INVENTION

Overview of Fibre Channel

A detailed overview of Fibre Channel is now given with reference to the accompanying drawings to illustrate a conventional buffer-to-buffer flow control mechanism which Fibre Channel and other upper layer protocols supported by Fibre Channel employ.

Firstly, Fibre Channel is a serial link supporting its own protocol as well as upper layer protocols such as FICON, FDDI, SCSI, HIPPI, IPI, IP.etc.

Protocols traditionally thought of as either channel or network may co-exist on a single Fibre channel physical layer. The lower Fibre channel transport layers are not aware of any “ULP” (Upper Layer Protocol) as is known to those skilled in the art.

Conventionally, Fibre Channel enables large amounts of information to be transferred rapidly. Transmission speeds include 133 Mbits/s, 266 Mbit/s, 530 Mbit/s, 1.0625 and 2.1250 Gbit/s (higher transmission speeds may be provided in future based on Fibre Channel principles). Fibre Channel is currently employed primarily within local area networks (LANs), and the invention enables a local Fibre Channel network to interconnect with other local Fibre Channel network(s) via synchronous network(s) more efficiently in terms of bandwidth than the prior art provides.

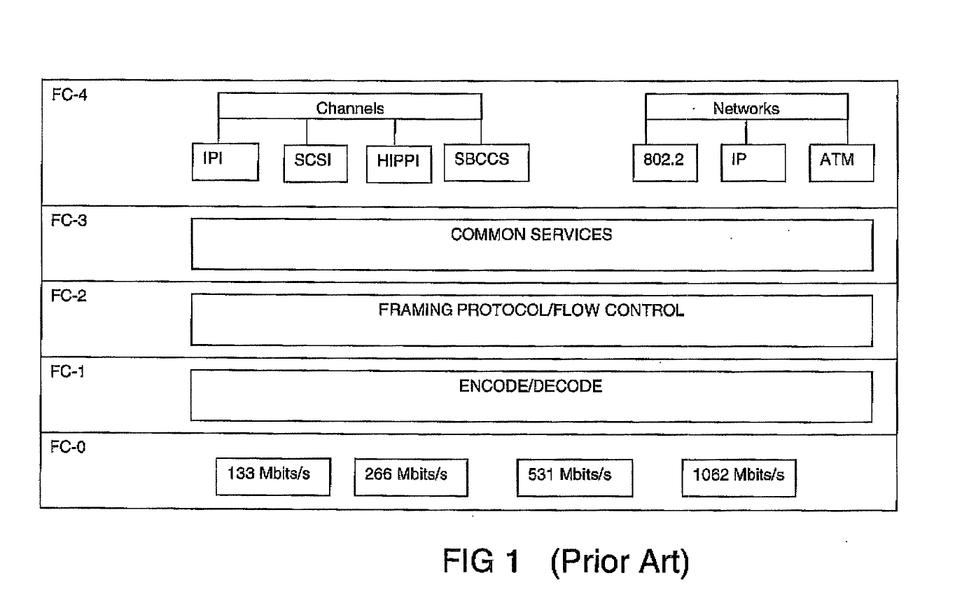

As is known to those skilled in the art, Fibre Channel is structured as a set of hierarchical functions (see FIG. 1 of the accompanying drawings). The lowest level FC-0 defines the physical link in the system such as the transmission speeds, FC-1 defines the line coding used to structure data according to the Fibre Channel protocol, FC-2 defines the framing protocol and flow control mechanisms to be used, FC-3 defines common services for certain advanced features, and FC-4 defines the application interfaces which can be executed over Fibre Channel.

FC-2 defines the transport mechanisms which include the framing rules for the data to be transferred between ports and various mechanisms for controlling the framing mechanisms and service classes, frame, sequence, exchange, and protocol building blocks.

The invention utilises the flow control mechanism which a packet oriented client signal such as Fibre Channel can provide at FC-2 of the hierarchy to optimise synchronous bandwidth usage when such client signals are mapped to synchronous payloads.

Fibre Channel uses 8B/10B line encoding to improve the transmission characteristics of the link. Within the 8B/10B line encoding scheme, certain basic signals, often termed “ordered sets” are defined which identify frame boundaries, transmit primitive function requests, and maintain proper link transmission characteristics during periods of inactivity. The term “ordered set” implies in this context a series of data/control characters which, when arranged in a particular order, represent a predefined meaning within the given protocol.

Three major types of ordered sets are defined by the Fibre Channel signalling protocol. These include:

i) frame delimiters such as start of frame and end of frame,

ii) primitive signals such as idles (which indicate an operational port facility ready for frame transmission) and receiver ready (R_RDY);

iii) primitive sequences which indicate specific conditions within a port or conditions encountered by the receiver logic of a port. Examples of primitive sequence include: offline, not operational, link reset, and link reset response.

Fibre Channel flow control depends on the service class. Classes are available for fractional bandwidth, unidirectional or multicast services, and the invention maps all classes of service in which buffer-to-buffer flow control is used ( for example, classes 2, 3 or 4). Fibre channel nodes perform a login process to establish a connection with the appropriate class of service. The login process determines what is present at the other end of the point-to-point link (i.e. whether it is another node, a loop or a switch) and communicates with it appropriately

Buffer-to-buffer flow control is managed between the ports of network nodes/switches connected in a point-to-point topology. The buffer-to-buffer flow control can only be implemented along a link between two Fibre Channel network elements (i.e., between two Fibre Channel network nodes or between a Fibre Channel node and a Fibre Channel switch fabric). The receiving port controls the transmission of frames by giving permission to the sending port to send one or more frame to that particular receiving port. That permission is called a credit. The number of frames that may be sent is referred to as the available credit. Flow control is provided by both ports on the link exchanging the number of frames they may receive at any time from each other to determine their respective buffer credit values during a “log on” phase.

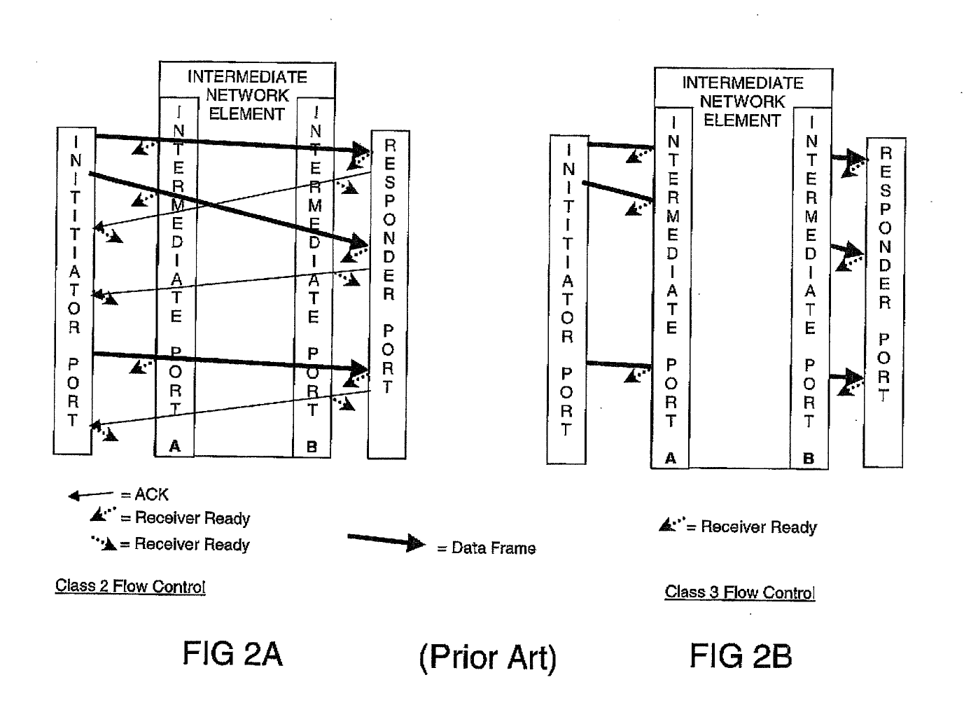

FIGS. 2A and 2B illustrate how conventional Fibre Channel signals are sent from a source (the initiator port) to a destination (the responder port) for both class 2 and class 3 service. As can be seen by comparing FIG. 2A with FIG. 2B, the essential difference is that class 2 signals are acknowledged by the responder port sending back an ACK frame in addition to a R_RDY primitive signal whereas no ACK is provided for Class 3 signals. This is because a class 2 service uses both buffer-to-buffer flow control and end-to-end flow control.

If the initiator port and port A of an intermediate network element (which may be a FC node or FC switch fabric) log into each other, the initiator port may indicate that it has sufficient storage capacity to handle 2 frames from port A, and port A may indicate that it can handle 8 frames from the initiator. Thus the buffer credit of port A is set to 2, and the buffer credit of the initiator port is set to 8.

Each port keeps track of the buffer credit count, which is initialised to zero. For each frame transmitted, the credit count is incremented by one, and for each R_RDY primitive signal received from the other port the credit count is decreased by one. Transmission of a R_RDY primitive signal indicates a port has processed a frame, freed a receive buffer, and is ready for one more. If the buffer credit count reaches the buffer credit value at the initiator pot, no more frames can be sent by the initiator to port A of the intermediate network element.

Similarly, for the link between port B of an intermediate network element and the responder port, if the buffer credit count at port B of the intermediate network element reaches its buffer credit value, no more frames can be sent.

It will be appreciated by those skilled in the art, that port A and port B as shown in FIGS. 2A and 2B may form part of the same intermediate network element, however more realistically several intermediate network elements may be provided and the illustrated example indicates only one intermediate network node for clarity.

Overview of ESCON

A detailed overview of ESCON is now given with reference to the accompanying drawings to illustrate a conventional buffer-to-buffer flow control mechanism which ESCON employs.

ESCON supports a packet oriented protocol. ESCON uses 8B/10B encoding to reduce transmission errors similarly to Fibre Channel and, like Fibre Channel, ESCON also provides ordered sets which include frame delimiters, primitive sequences and primitive signals similar to those defined by FC. ESCON also provides a link level protocol to establish and maintain the physical and logical paths used for transferring frames, The link layer must be established before data level commands and statuses may be exchanged ESCON uses a similar buffer-to-buffer flow control mechanism like certain classes of Fibre Channel.

In ESCON, flow control is achieved using an ESCON channel control word such as, a common link access word, which ensures that the size of the ESCON transmit channel is less than or equal to the size of the host ESCON receive channel. If an ESCON channel receives more data than it can accommodate in a buffer, more buffers are allocated until all the data is transmitted or until no more buffers are available. When no more buffers are available, the channel access control word is retried, and when more buffers are available, the data transfer is continued.

As a channel is only capable of restarting data transfer at the beginning of a channel control word, multiple attempts to receive one block of data are avoided by ensuring that the channel link access word (CLAW) frame size is less than or equal to the receive size. This allows data to be transferred along the ESCON channel only whenever a buffer is available and so avoids multiple transmissions of data. If the CLAW frame size is not large enough to hold a complete block of data from an application, a More-to-Come bit can be set. This bit indicates to the application or operating system application interface that this CLAW frame does not contain all of the data for this block and more data will arrive in a subsequent frame. The specific use of the More-to-Come bit can be tailored to the environment of the operating system.

The best mode of the invention will now be described with reference to the accompanying drawings. It will be appreciated by the person skilled in the art that the invention is not intended to be limited to the specific embodiments described herein below but extends to suitable equivalents falling within the scope of protection defined by the claims.

The invention applies to packet oriented client signals provided according to a link protocol having a buffer-to-buffer flow control mechanism, for example, Fibre Channel, ESCON, etc, so that buffer-to-buffer flow control may be handled conventionally by the client signal equipment, which generates and/or terminates the client signal. Whilst specific reference is made to a Fibre Channel (“FC”) embodiment of the inventions those skilled in the art will appreciate that the invention can be readily adapted to client signals provided using ESCON, and to other suitable packet oriented protocols which use buffer-to-buffer flow control mechanisms, in particular to such protocols which are supported by Fibre Channel and use Fibre Channel flow control techniques.

The invention enables dispersed packet oriented networks to communicate over synchronous networks, for example synchronous optical networks such as SONET or SDH networks. An example of a packet oriented network is a Fibre Channel storage area network (“SAN”).

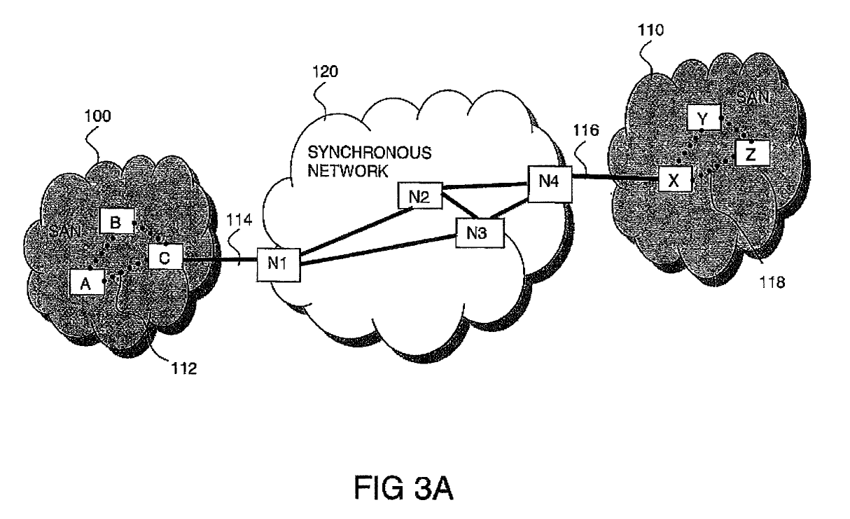

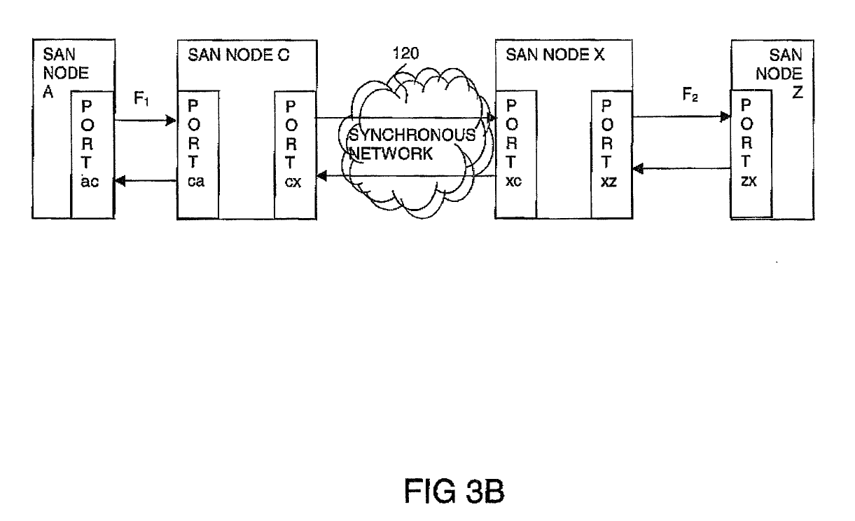

Referring now to FIG. 3A, an embodiment of the invention will now be described in which a first packet oriented network 100 uses a link protocol having buffer-to-buffer flow control for data transfers between a plurality of network elements (NEs) A, B, and C. First network 100 is connected to a second packet oriented network 110. Second network 110 comprises a plurality of NEs X, Y, Z, and may also be a SAN and supports the same protocol as the first network 100. Each network element A, B, C, X, Y, Z includes nodes having ports enabling the ingress/egress of traffic from/to the NE. The two packet oriented networks 100, 110 are connected by a synchronous digital network 120, for example a SONET or SDH network. In this embodiment of the invention, both the first and second packet oriented networks 100, 110 use a Fibre Channel class of service employing buffer-to-buffer flow control between their respective NEs. Here the term “client signal” refers to a signal which has buffer to buffer flow control which can be transported over the first and second packet oriented networks.

As an example, in order to send a signal from network element A to network element Z the following steps are performed according to the invention:

i) a login procedure is initiated at the Fibre Channel ports at each end of each link between network element A and network element Z to establish appropriate buffer credit values for each port.

Firstly, the interfacing ports on link 112 between node A and node C login to each other to determine their buffer credit values. Secondly, the interfacing ports in nodes C and X communicate transparently across the synchronous network 120 to log in to each other, and finally the interfacing ports along the link between nodes X and Z log in with each other to determine their buffer credit values.

ii) a signal is transmitted from a source, the initiator port “ac” of node A, to its destination (the responder port “zx” of node Z) and the flow of the signal is controlled using the buffer credit values determined in step (i) which are communicated transparently over the synchronous network 120 as will be described in more detail later herein below.

Advantageously, flow control through the interfacing synchronous network elements, for example nodes N1, N4 in FIG. 3A, of the synchronous network 120 is determined by the Fibre Channel equipment that generates the Fibre Channel signal, i.e., by node C of SAN 100 (and by node X of SAN 110 for bi-directional signals).

The synchronous network 120 is transparent to the flow control of the packet oriented protocol, i.e., the synchronous network elements etc N1, N2, N3, N4 do not manipulate the data packet protocol flow control Flow control over the synchronous network is determined instead by the first network 100 and second network 110 interfacing nodes, for example by the buffer credit values established by NEs C and X.

Referring now to FIG. 3B, the above steps will be considered with reference to a specific example. Consider the case where along link 112 port “ac” of the node at A is granted a buffer credit value of 10 by port ca of the interfacing node of C. This means that if the receiving buffer of port “ca” is initially empty, port “ac” can send up to 10 frames to port “ca” before the buffer of port “ca” is full (assuming that the buffer of port “ca” does not in the meantime empty). Consider also the case where interfacing port “ca” of C is granted a buffer credit value of 5 by port “ac” of A (i.e. similarly, port “ca” can send 5 frames to port ac).

Port “ac” is aware of the number of frames it sends to “ca” reducing its buffer credit for that port, and correlates this with the number of receiver ready signals it receives from port “ca” which replenishes its buffer credit. If the buffer credit count at port “ac” reaches the buffer credit value for port “ca”, no more frames are sent to port “ca” until a R_RDY primitive signal is received from port “ca” to indicate that port “ca” has now freed a buffer.

To implement flow control between C and X, appropriate buffer credit values are determined transparently across the intermediate synchronous network 120 and any intermediate synchronous NEs/nodes. For example, if at C, port “cx” is granted a buffer credit value of 20 by port “xc” of X, port “cx” can send up to 20 frames at a time to port “xc”. Similarly, if at X, port “xc” is granted a buffer credit value of 10 by port “cx”, port “xc” can send up to 10 frames at a time to port “cx”.

Completing the link between A and Z, consider if Port “xz” of X is granted a buffer credit value of 5 by port “zx” of Z and port “zx” is granted a buffer credit value of 10 by port “xz”. This means “xz” can send 5 frames to port “zx” and “zx” can send 10 frames to port “xz”, before the buffers in each port will, if they are not emptied in the meantime, be full.

Accordingly, in the embodiment shown in FIG. 3B, the Fibre Channel service provides a total of 35 buffer credits along the communications path between A and Z. (i.e. the summation of the buffer credit values stored at ports “ac”, “cx” and “xz” for 10+20+5=35), and a total buffer credit value of 25 is provided for the reverse direction

Ideally, therefore A can send 35 frames from initiator port “ac” to the responder port “zx” at Z before buffer credit regulates the flow control and transmission is paused until a buffer is freed. However, if C cannot transmit to X, a pause may occur after only 10 frames have been transmitted. This initiates a chain of receiver ready signals being transmitted back down the line to port “ac”. When port “ac” receives a receiver ready signal from port “ca”, it is able to send another frame of data.

Thus, the interfacing node of C in the first network 100 can only send a frame across the synchronous network 120 if the receiver node of X in the second network 110 has indicated it can accept the frame For a communication between node C and node X, the number of buffer credits held at node C controls the flow of frames to the interfacing synchronous node N1. The receiver port indicates that a frame can be accepted by sending R_RDY's to the trasmitter port, and thus flow control is provided completely within the packet orientated client network environments of first and second networks 100, 110 without the need to adapt any intermediate equipment in the synchronous network 120 via which the two networks 100, 110 are able to communicate.

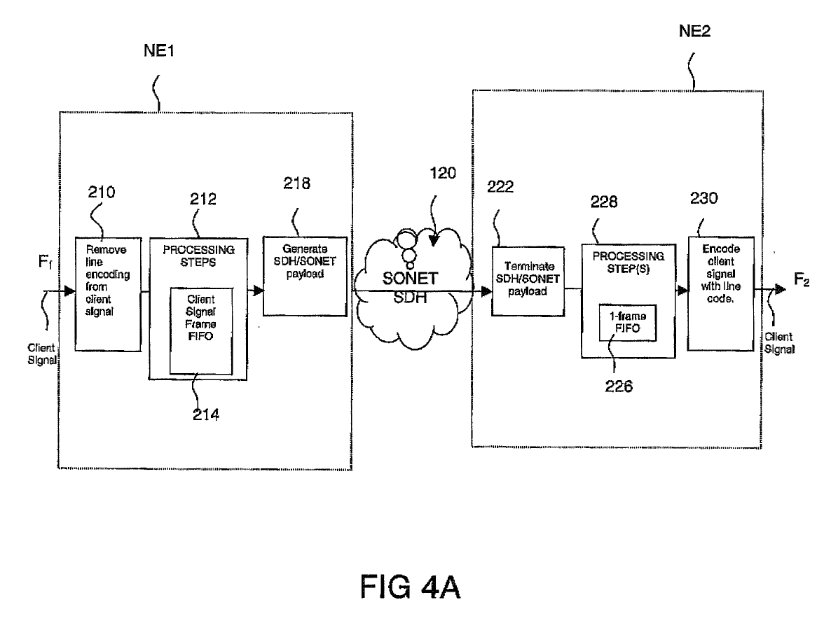

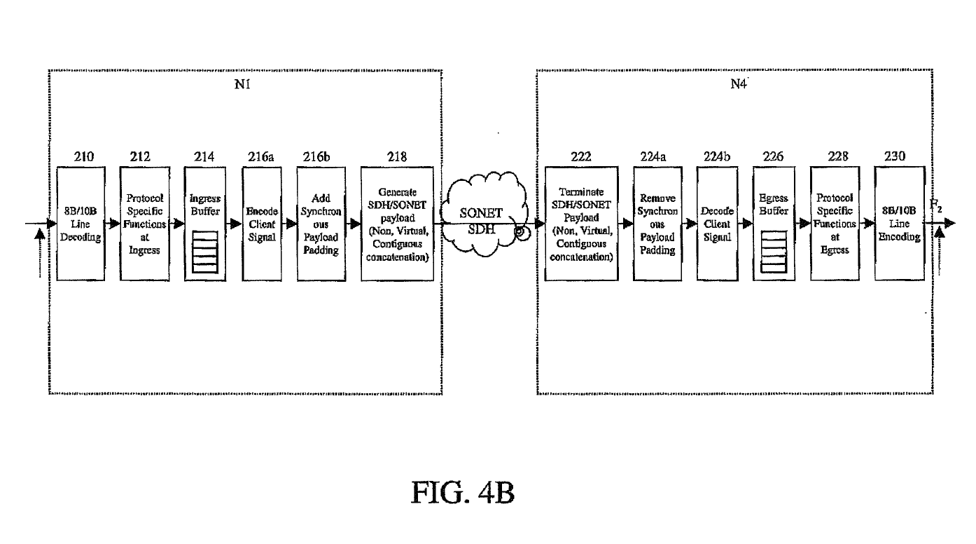

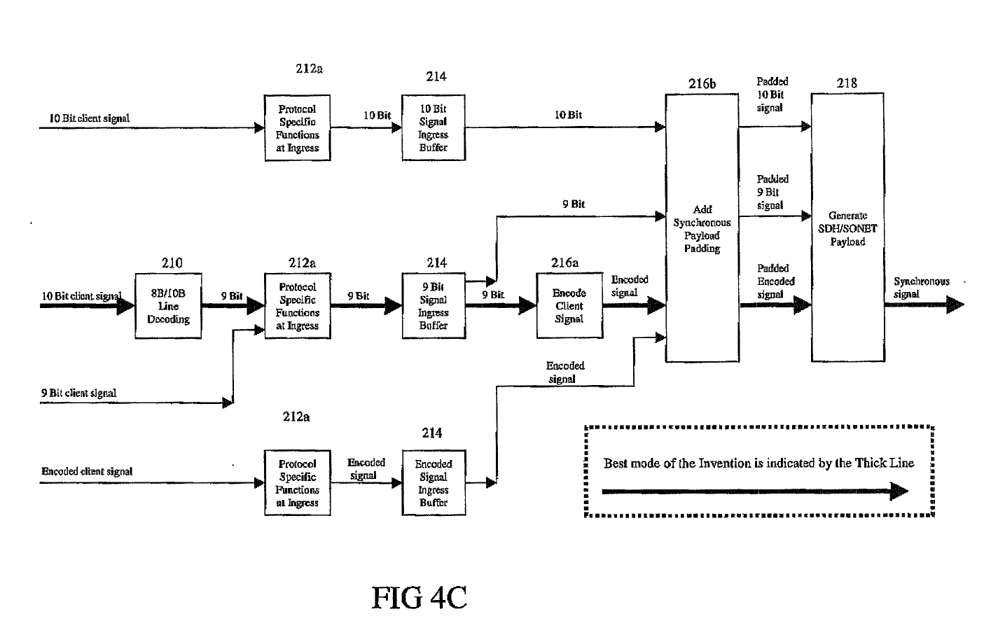

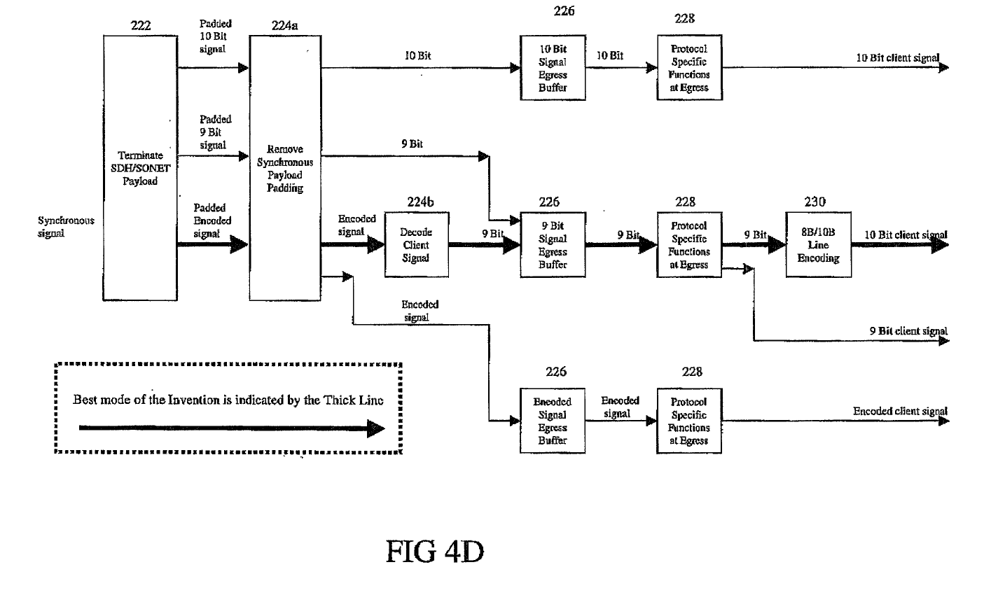

FIG. 4A shows more details of how a packet oriented signal F₁ is communicated between the first and second packet oriented signal networks 100, 110 over a synchronous network 120 in one embodiment of the invention. In FIG. 4, the signal F₁ is received from the first network 100 and is mapped into a synchronous network payload at synchronous node N1. In this embodiment of the invention, node N1 receives packet oriented client signals having buffer-to-buffer flow control provided by interfacing NE “C” in the first network 100.

N1 interfaces between first network 100 and the synchronous digital network 120 and N4 interfaces between the synchronous digital network 120 and second network 110 as shown in FIG. 3A. Both N1 and N4 in this embodiment of the invention are provided within synchronous network equipment adapted to support the reception/generation of packet oriented client signals and support buffer-to-buffer flow control. Alternatively, some or all of the steps shown in FIG. 4A may be performed within the packet oriented client network equipment providing flow control, i.e. by C, or by X. In other alternative embodiments of the invention, N1 may be provided by more than one piece of equipment, for example, such that at least the mapping function is provided within synchronous network equipment.

The embodiment of the invention shown in FIG. 4A comprises the following steps, which are described in more detail later herein below.

Step 208 (not shown)—receive signal F₁;

Step 210—remove line encoding from F₁;

Step 212—process the decoded signal;

Step 214—store processed signal in ingress buffer;

Step 216a (not shown, see FIG. 4B)—encode the signal to a form suitable for mapping; Step 216b (not shown, see FIG. 4B)—add synchronous payload padding;

Step 218—generated synchronous network payload by mapping the transport encoded signal to synchronous network payload(s);

Step 220 (not shown) send over the synchronous network 120,

Step 222—terminate synchronous network payload;

Step 224a (not shown, see FIG. 4B)—removed synchronous payload padding;

Step 224b (not shown, see FIG. 4B)—decode signal after transport;

Step 226—store signal in egress buffer;

Step 228—process the signal at egress;

Step 230—line encode the signal to restore the client signal regenerated as client signal F₂.

FIG. 4A shows the basic key steps in the invention. The additional steps transport encoding and padding steps shown in FIG. 4B are provided in the best mode of the invention. Alternative embodiments of the invention may implement equivalent steps or substitute or omit some of these steps as shown in FIGS. 4C, and 4D.

Step 210—Line Decoding

Referring to FIG. 4B, step 210, the client signal is received as a 10B encoded signal. In this embodiment of the invention the Fibre Channel 10B line encoded signal is decoded to 9B before transport across the synchronous network. In Fibre Channel and ESCON embodiments of the invention, a 10B/8B line coding implies the line encoded signal will be decoded to 8 bits. However, in fact the line encoded signal is decoded to 9 bits (i.e. one K/D character recognition bit followed by the 8B representation of the 10B control/data character). This, for example, would result in bandwidth reduction of the 1062.5 Mbps Fibre Channel client signal physical rate to 956.25 Mbps.

As a number of data rates are associated with packet oriented client signals, these will now be briefly described. Here the “physical rate” of the client signal is the actual bit rate as transmitted on the physical medium, for example on the fibre or coaxial cable. The “full bandwidth” of the client signal is the data rate when operating at its maximum rate, usually with maximum packet size with minimum inter packet gaps.

The actual bandwidth of the client signal is the data rate representing the actual data rate of the client signal. This may be any value between zero and the full bandwidth rate. When the actual rate is less than the full bandwidth rate, padding characters are inserted to fill out the bandwidth. These padding characters (known as Idles within both Fibre Channel and ESCON) carry no useful information and transporting them on a SDH/SONET network uses up costly transport bandwidth.

In an alternative embodiment of the invention, the client signal may be received without 10B line encoding, for example if the invention was realised in the same equipment that is generating the client signal. 10B line encoding is only required for transmitting over fibre optic cables, hence would not typically be used internal to a piece of equipment. In such embodiments, the signal could be received in a number of formats, as those skilled in the art would appreciate. Possible formats would be a 9-bit format (i.e. 8 bits data plus K/D bit), or some other form of encoded signal. This invention is equally applicable to these or any other format used

Step 212—Processing the Received Signal

The received signal is then processed to have a form suitable for mapping to one or more synchronous network payloads, i.e. to a SONET/SDH virtual container or two or more virtual containers which are suitably concatenated/virtually concatenated.

Each packet oriented protocol has an associated set of protocol specific functions (which are represented by signals comprising ordered sets) which are used to perform processes such as flow control, framing, transport etc. Although protocol specific functions do not carry any client data they are required for effective transport of data between two client ports.

In the case where the two client ports are separated by a synchronous transport network as in FIG. 3A, certain ordered sets in the packet oriented signal are redundant, and can be removed to reduce the bandwidth of the signal to enable more efficient use of the transport network in step 212a (see FIG. 4B).

In the embodiment of the invention using Fibre Channel, client idles and primitive sequences can be removed before transport across that network. All non-redundant ordered sets such as primitive signals associated with the flow control (e.g. R_RDYs) and frame delimiters must remain in the data stream.

Accordingly, in the best mode of the invention the client idles and primitive sequences are removed from the 9B line decoded client signal in step 212a. In alternative embodiments of the invention the client idles and primitive signals are removed from the 10B line encoded client signal or from any other encoded representations of the client signal. These alternative embodiments are depicted in FIG. 4C.

Client Idles are used as padding within the client signal and carry no useful information. These can therefore be removed without removing any information from the signal. In the best mode of the invention all the client signal idles are removed to maximise the reduction of bandwidth, but in fact a certain portion of idles can remain if desired.

Client Signal Primitive Sequences are sent between packet oriented client signal nodes on a link to indicate a particular state of operation. Although, only a single primitive sequence is enough to represent the state, they are sent continuously to fully fill the client signal bandwidth, usually until some response is received from the receiving node. A series of Primitive Sequences is compressed in order to fit in a reduced size synchronous payload. This can be easily achieved due to the obvious redundancy in the signal. For example, for each one hundred primitive sequences received, ninety nine could be deleted and only one transmitted on the synchronous network. An alternative example might be to delete just enough primitive sequences to fully fill the synchronous payload. Another example might be to encode a certain number of primitive sequences (e.g. 100) in a single code for transport.

This step applies to any primitive sequence or any other periodically repeating sequence of bits, as those skilled in the art would recognise.

Step 214 Storing Client Signal in Ingress Buffer

Referring again to FIG. 4A, once redundant information has been removed (i.e. after removing Idles and Primitive Sequences) the processed signal is stored in an ingress buffer in step 214. The ingress buffer is required to store client data prior to transport on the synchronous network and to hand off data between the client signal data rate and the synchronous payload rate, which can be significantly smaller.

The ingress buffer must ensure that data cannot be lost due to buffer overflow. To ensure the ingress buffer does not overflow, it must be large enough to cope with any build-up of data frames, as the data frames may be arriving at a rate much faster than they can be transported on the synchronous network 120.

The minimum amount of storage capacity provided by ingress buffer at interfacing synchronous network element node N1 in FIG. 3A is determined by the number of buffer credits along the communications link between the transmitting node C and the receiving node X in this embodiment of the invention, i.e. by the buffer credit value for the link between the two packet oriented network elements “C” and “X”.

As long as the ingress buffer is equal to or larger than the number of buffer credits on this link, it is guaranteed not to overflow due to the flow control mechanisms of the client signal. It should also be noted that the buffer must also contain enough additional storage capacity to store the frame delimiters and the small number of other primitive signals that could be transmitted between frames. The size of the buffer must also take into account the format in which the client signal is being transported. Depending on which embodiment of the invention is used, the client data could be represented as 10 bit, 9 bit or some other encoded representation of the client signal.

There is no limit on the maximum size of the buffer. A buffer that is much larger than is needed does not impose any restrictions on the invention.

Consider, for example, an embodiment of the invention where node “C” has a buffer credit value of “20” for the receiving port at node “X”, this means that if node “X” does not empty its buffers, node “C” can only transmit 20 frames of data before having to pause. If the client signal rate over the first network 110 is significantly larger than the synchronous signal rate, the ingress buffer 214 may receive all 20 frames before it is able to transmit even a single frame on the synchronous network. It therefore must provide sufficient storage capacity to store the 20 frames of data that port “cx” of the node of “C” could transmit before pausing.

The skilled person familiar with the art will, however, note that for ESCON, the size of ingress buffer depends on the mode of operation of ESCON equipment, and that generally a 128 frame ingress buffer will work for both modes, given the maximum ESCON frame size of 1024 bytes.

In the best mode of the invention, the signal is stored as a 9B signal. In alternative embodiments of the invention the client signal is stored as a 10B signal or any other encoded representations of the client signal.

In the best mode of the invention, the ingress buffer will be equal to or larger than the number of buffer credits on the link. It will however be appreciated by those skilled in the art that in some specific embodiments of the invention, the ingress buffer could be smaller than the number of buffer credits on the link.

Step 216A—Encoding the Client Signal

Step 212—processing the signal to a form suitable for mapping to one or more synchronous payload(s) may also include step 216a, an encoding step. As shown in FIG. 4B, in step 216b, the 9 bit representation of the client signal is encoded to further reduce its bandwidth in order to make more efficient use of the synchronous bandwidth. Any number of encoding techniques could be employed for this as long as the client signal (after removal of Idles and Primitive Sequences) can be fully re-constituted following transport through the synchronous network. As those skilled in the art would appreciate, the 9-bit representation of the client signal contains a lot of redundancy. Each of the 9 bit Data characters can be encoded to their 8 bit representations by removal of the D character recognition bit. Ordered Sets which contain K characters are more difficult to encode such that they can be re-constituted after transport, however, one technique achieving this is described in the T1X1 standard. A suitable encoding technique should be capable of reducing the bandwidth of the client signal from 956.25 Mbps to approximately 850 Mbps. Several mapping schemes which are able to implement suitable encoding are known to those skilled in the art. Suitable encoding enables suitable framing information, for example regarding the start and end of packets to be provided when such packets are mapped to synchronous payload, in particular for example when the payload comprises more than one virtual container as would be apparent to those skilled in the art.

Step 216B—Add Synchronous Payload Padding

The step of processing the signal to a form suitable for mapping to one or more synchronous payload(s) (step 212) also includes, in the best mode of the invention, padding the signal where appropriate (step 216B). It is necessary to be able to pad out the synchronous payload should the client signal data rate fall below the synchronous payload rate. If this situation occurs, it will result in the ingress buffer emptying. When the buffer empties or falls below a pre defined level, padding characters must be inserted. A technique for doing this has already been devised by T1X1 standards body, however many other similar mechanisms could be used.

In other embodiments of the invention, the padding is applied to the 10B or 9B representation of the client signal as appropriate (see FIG. 4C)

Step 218—Generate SDH/SONET Payload

The invention is able to support any synchronous payload rate, including payloads which are significantly smaller than the full bandwidth of the client signal. In step 218, the synchronous payload is generated by mapping the client signal (which will have been padded if the client signal data rate falls below the synchronous payload rate) into a suitable number of virtual container(s). An appropriate path overhead is created for transmission of the payload over the synchronous network 120.

The client signal data stream is mapped into at least one synchronous container, for example a virtual container or to a plurality of concatenated (virtual) containers for transportation over the synchronous network 120. The concatenated (virtual) containers may be either contiguously or virtually concatenated. However, it is preferable for virtual concatenation to be used as this provides several advantages, in particular, the range of bandwidths is much greater and hence can be chosen to more accurately meet the customer requirements.

Once the client signal data has been mapped to an appropriate synchronous payload, the signal is transmitted across the synchronous network 120 from the first interfacing synchronous network node N1 to a second synchronous network node N4 (see FIG. 3A).

Step 222—Terminate SDH/SONET Payload

In step 222, at node N4 the synchronously framed signal is demapped from the virtual container(s) and the path overhead terminated, using a suitable technique such as is known to those in the art.

Step 228—Process the Signal to Restore the Packet Oriented Client Signal

Once recovered from the synchronous payload, the signal is processed to restore it to a packet oriented client signal form suitable for transmission over the second network 110. A number or processing steps may be performed to restore the packet oriented client signal:

Step 224A—Remove Padding

In step 224a, any synchronous payload padding that was inserted prior to transport is removed.

Step 224—Decode Transport Encoded Signal

In step 224b, if the signal was encoded prior to transport on synchronous network, the signal is decoded in order to recover the client signal. It will be appreciated that unpadding and decoding is only required if the signal has been padded and coded for transport prior to transmission over the synchronous network 120.

Step 226—Store Client Signal in Egress Buffer

Referring again to FIGS. 4A and 4B, in step 226 the client signal is stored in an egress buffer. The egress buffer is required to buffer the received signal from the synchronous network and to hand off data between the synchronous payload rate and the client signal data rate, which may be significantly faster.

To achieve hand-off between the synchronous payload rate and the client signal rate, the egress buffer must have at least a 1-frame client signal capacity. This enables complete frames to be received from the slower synchronous network before being sent to the client interface, and therefore ensures that the frame is sent continuously without any gaps. Idles are not permitted in mid-frame. In the case of Fibre Channel, the 1-frame egress buffer holds 2140 bytes, however, in other alternative embodiments of the invention, the frame size may differ. In the best mode of the invention, the signal is stored as a 9B signal. In alternative embodiments of the invention the client signal is stored as a 10B signal or any other encoded representations of the client signal.

For ESCON, the 1-frame Egress Buffer 228 is 1024 bytes.

Step 228A—Perform Protocol Specific Functions at Egress

In FIGS. 4A/4B, the client signal is first extracted from the egress buffer. To rate adapt between the client signal received from the transport network and client signal data rate, padding of the client signal is performed where appropriate. If data frames are being received, then an appropriate number of idles must be inserted into the client signal according to the appropriate client signal protocol rules. The idles do not however have to be inserted at the points they were removed prior to transport on the synchronous network. Primitive sequences are inserted where appropriate as per client specific protocol rules.

Step 230—Line Encoding

Step 230 of FIG. 4B shows how in this specific embodiment of the invention where the best mode is implemented, the client signal is line encoded before transmission as signal F₂ over the second network 110. For example, where second network 110 supports Fibre Channel (as does the first network 100 in this specific embodiment of the invention), the signal may be line encoded using 8B/10B line encoding, before transmitting, for example, on a local client signal fibre optic cable.

FIG. 4D shows some alternative steps according to other embodiments of the invention.

FIGS. 4A, 4B, 4C, and 4D thus show various steps in the method of mapping a packet oriented signal using buffer-to-buffer flow control from a first packet oriented client network 100 capable of supporting the buffer-to-buffer flow control to a second packet oriented client network 110 capable of supporting the buffer to buffer flow control over a synchronous network 120.

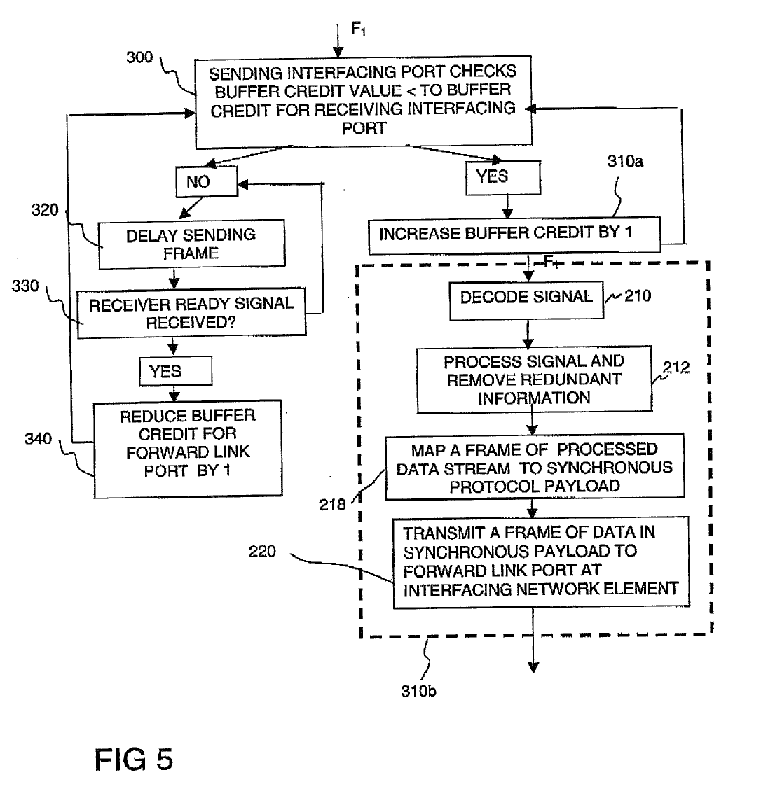

FIG. 5 shows how the flow control is separated from the mapping process. In FIG. 5, the sending port of the node in “C” of the first network 100 checks its buffer credit count at port “cx” against the buffer credit value assigned to it in step 300, prior to sending a frame in client signal F₁ to synchronous network node N1. Using the previous values given in the specific example, C checks if the buffer credit count for “cx” is larger than the assigned value of 20.

If the sending port “cx” (see FIG. 3 A for example) of the node in C does not have a sufficient buffer credit count, i.e., if the buffer credit count is equal to 20, then a frame is not sent to node N1 in the synchronous network 120 and the frame is delayed (step 310). C continues to monitor the buffer credit count against the buffer credit value assigned to “cx”. When a receiver ready signal is received (310), the buffer credit count falls (320), and the next check (310) results in a frame of signal F₁ being sent to equipment performing the mapping to synchronous payload (step 310b) and the buffer credit of “cx” rising by 1 again (step 310a).

As FIG. 5 shows, the flow control is excluded from the method of mapping steps which are encapsulated as indicated by the dashed box outline.

By performing the mapping from Fibre Channel directly to the synchronous payload, a client signal can be mapped to synchronous payloads which have a smaller bandwidth than the original signal. Moreover, by using the Fibre Channel flow control, bandwidth can be provided in response to demand.

The invention provides a means to adjust flow of the client signal in response to the network conditions and provide an appropriate amount of bandwidth on demand without costly modification of the SAN node equipment.

The above description is directed towards a fibre channel embodiment of the invention. However, embodiments of the invention where the client signal conforms with the ESCON packet oriented protocols can be implemented in a similar manner as will be apparent to those skilled in the art. Similarly, other packet oriented protocols using buffer to buffer flow control mechanisms which are implemented in a manner similar to that described above may be used in a similar manner such as would be apparent to those skilled in the art.

Any range or device value given herein may be extended or altered without losing the effect sought, as will be apparent to the skilled person for an understanding of the teachings herein.

For example, a client signal may be mapped into a variety of synchronous container payloads and combinations thereof, as would be obvious to those skilled in the art.

Also, a variety of different rates exist within Fibre Channel and within other data packet protocols having buffer-to-buffer flow control, and the invention is not limited to any specific rate as would be obvious to those skilled in the arts.

Those skilled in the art will appreciate that the invention may be implemented using ASIC or FPGA technology and incorporated within. either data packet protocol equipment (e.g. within a Fibre Channel Network Element), or within synchronous network equipment, for example, a SONET or SDH Network Element. The buffers are implemented in memory, for example, in RAM.

It will also be appreciated by those skilled in the art that the synchronous, e.g., SDH/SONET, bandwidth can be automatically allocated by the node implementing the mapping or can be provisioned by network management.

The method also provides a means to perform load balancing across the network using virtually concatenated synchronous payloads whose bandwidths and routes can be selected according to the prevailing network conditions.

The text of the abstract repeated below is considered part of the description of the above invention:

A method of transporting a packet oriented client signal which uses a buffer-to-buffer flow control mechanism over a synchronous transmission network by assigning an arbitrary synchronous payload, where the synchronous payload bandwidth may be significantly smaller than the full bandwidth of the client signal. Flow control over the synchronous network is provided by the buffer-to-buffer flow control mechanism of the client signal to automatically regulate the data throughput to ensure no data can be lost. The method is independent of the Client Signal Data Rate and the provisioned SDH/SONET bandwidth, and SDH/SONET payload which may be non-concatenated, contiguously concatenated, or virtually concatenated. In particular, the method may be used to support the transport of Fibre Channel (1G, 2G and 4G), and ESCON (200M) in a synchronous payload.

Modifications and improvements may be incorporated herein without departing from the spirit and scope of the invention which is as defined by the accompanying claims.

1. A method of mapping a packet orientated client signal to a synchronous network payload, the method including the steps of:
receiving said client signal;
processing said client signal to a form suitable for mapping to said payload which preserves a buffer-to-buffer flow control mechanism of the client signal, wherein said step of processing reduces the bandwidth of the client signal while maintaining the integrity of a payload of the client signal;
and mapping said processed signal to said synchronous network payload.

2. A method as claimed in claim 1, wherein the bandwidth is reduced by removing redundant information from said client signal.

3. A method as claimed in claim 1, wherein the bandwidth is reduced by removing idles from said client signal.

4. A method as claimed in claim 1, wherein the bandwidth is reduced by removing at least one primitive sequence which forms part of a series of repeated primitive sequences in said client signal.

5. A method as claimed in claim 1, wherein in the step of preserving the buffer-to-buffer flow control mechanism of the client signal, said buffer-to-buffer flow control mechanism is provided according to a Fibre Channel protocol class of service.

6. A method as claimed in claim 1, wherein in the step of preserving the buffer-to-buffer flow control mechanism of the client signal, said buffer-to-buffer flow control mechanism is provided according to an ESCON protocol class of service.

7. A method as claimed in claim 1, wherein said packet orientated client signal is provided according to a higher level protocol supported by said Fibre Channel protocol and which has a buffer-to-buffer flow control mechanism provided according to a Fibre Channel protocol class of service.

8. A method as claimed in claim 1, wherein the synchronous payload is taken from the group consisting of: one or more SONET virtual container payloads, one or more SDH virtual container payloads; two or more virtually concatenated SONET virtual container payloads; two or more virtually concatenated SDH virtual container payloads; two or more contiguously concatenated SONET virtual container payloads; two or more contiguously concatenated SDH virtual container payloads.

9. A method as claimed in claim 1, wherein said step of processing the client signal further includes a step of removing line encoding.

10. A method as claimed in claim 1, further including the step of padding said processed client signal so that said processed client signal is appropriately padded to fill a predetermined synchronous payload bandwidth.

11. A method as claimed in claim 1, wherein the bandwidth of the synchronous payload is allocated by a network management system.

12. A method as claimed in claim 1, wherein the bandwidth of the synchronous payload is allocated by an apparatus implementing the method of mapping.

13. A method of mapping as claimed in claim 1, wherein the synchronous payload bandwidth is modified in response to customer bandwidth demands increasing/decreasing.

14. A method of mapping as claimed in claim 17 wherein the synchronous payload bandwidth is modified in response to changes in data throughput as distance between the end data packet nodes changes.

15. A method as claimed in claim 1, wherein a plurality of clients signals are multiplexed together to share said synchronous payload.

16. A method of mapping a packet oriented client signal that uses a buffer-to-buffer flow control mechanism to a synchronous transmission network payload, the method comprising the steps of:
processing said client signal to remove at least one ordered set provided according to a protocol of said client signal to form a second signal;
storing the second signal in an ingress buffer; and
mapping the second signal to said synchronous payload,
wherein said steps of processing said client signal and mapping said second signal preserves the buffer-to-buffer flow control mechanism of the client signal and maintains the integrity of the payload of the client signal.

17. A method as claimed in claim 16, wherein said ordered set provides redundant data in said client signal.

18. A method as claimed in claim 16, wherein said ordered set provides redundant data comprising at least one client signal idle.

19. A method as claimed in claim 16, wherein said ordered set provides redundant data comprising at least one client signal primitive sequence which is repeated in a series of client signal primitive sequences

20. A method of restoring a packet oriented client signal from at least one synchronous network payload, the method comprising the steps of:
receiving said synchronous payload;
de-mapping said signal from said synchronous payload;
storing said signal in an egress buffer; and
processing said signal to add at least one ordered set provided according to a protocol of said packet orientated client signal, wherein said method of restoring the client signal maintains the integrity of the payload of said packet oriented client signal and preserves a buffer-to-buffer flow control mechanism of said client signal.

21. A method as claimed in claim 20, wherein said step of de-mapping includes removing at least one padding character added to said signal prior to being mapped to said synchronous payload.

22. A method as claimed in claim 20, wherein said at least one ordered set is a client signal idle inserted between client signal packets in said signal according to the client signal protocol.

23. A method as claimed in claim 20, said at least one ordered set is a primitive sequence inserted to form a series of primitive sequences in accordance with the client signal protocol.

24. Apparatus adapted to perform steps in a method of mapping a client signal comprising a packet oriented client signal that uses a buffer-to-buffer flow control mechanism to a synchronous transmission network payload, the apparatus comprising:
a processor for processing said client signal to remove at least one ordered set provided according to a protocol of said client signal to form a second signal;
a buffer for storing the processed client signal in an ingress buffer; and
a mapper for mapping the processed client signal to said synchronous payload,
wherein said apparatus preserves the buffer-to-buffer flow control mechanism of the client signal and maintains the integrity of the payload of the client signal.

25. Apparatus as claimed in claim 24, wherein the apparatus is provided in a network element supporting said client signal.

26. Apparatus as claimed in claim 24, wherein the apparatus is provided in a network element supporting said synchronous network payload.

27. A network element comprising apparatus as claimed in claim 25.

28. A network element comprising apparatus as claimed in claim 26.

29. A signal comprising a set of one or more synchronous containers, wherein the payload of said one or more synchronous containers comprises a client signal adapted to a reduced bandwidth format, wherein the integrity of the payload of said client signal is preserved in said synchronous payload, and wherein a buffer-to-buffer flow control mechanism of said client signal is preserved in said synchronous payload.

30. A method of load balancing traffic comprising a packet orientated client signal across a synchronous network, wherein said traffic comprises at least one synchronous network payload comprising a packet oriented client signal which is controlled by a buffer-to-buffer flow control mechanism, the signal having been mapped to a synchronous network payload, using a method including the steps of: receiving said client signal; processing said client signal to a form suitable for mapping to said payload which preserves a buffer-to-buffer flow control mechanism of the client signal, wherein said step of processing reduces the bandwidth of the client signal while maintaining the integrity of a payload of the client signal; and mapping said processed signal to said synchronous network payload, wherein said method of load balancing comprises the steps of:
pre-allocating an initial bandwidth of said synchronous network payload according to a predetermined condition, wherein said payload comprises a plurality of virtually concatenated virtual containers;
diversely routing said synchronous network payload over said synchronous network; and
in the event of a change in a condition of the network, modifiying the allocated bandwidth.

31. A method of load balancing traffic as claimed in claim 30, wherein bandwidth is automatically modified.

32. A method of load balancing traffic as claimed in claim 30, wherein the bandwidth is automatically modified by the apparatus performing the method of mapping.

33. A method of load balancing traffic as claimed in claim 30, wherein said pre-allocation bandwidth is determined by requirements requested by a user of the network.

34. A method of load balancing traffic as claimed in claim 30, wherein said pre-allocation is automatic.

35. A method of load balancing traffic as claimed in claim 30 wherein said pre-allocation is determined by the condition of the synchronous network.

36. A method of allocating bandwidth in a synchronous digital network for a packet oriented signal having buffer-to-buffer flow control, the method comprising the steps of:
received said packet oriented signal;
processing said packet oriented signal to a processed signal having a form suitable for mapping to a synchronous network payload, wherein the processing preserves a buffer-to-buffer flow control mechanism of said packet oriented signal, wherein said step of processing removes redundant information from the packet oriented signal while maintaining the integrity of a payload of the packet oriented signal;
and mapping said processed signal to a said synchronous network is payload having a bandwidth determined according to the bandwidth of said processed signal.
